(19) United States
(12) Patent Application Publication
(10) Pub. No.: US 2020/0308479 A1
(43) Pub. Date: Oct. 1, 2020

(54) LUMINESCENT INSERT FOR A CONSTRUCTION ELEMENT, ASSOCIATED ELEMENT AND MANUFACTURING METHOD

(71) Applicant: CHRYSO, ISSY LES MOULINEX (FR)

(72) Inventor: Jean-Jacques HIVERT, MAREAU AUX BOIS (FR)

(21) Appl. No.: 15/779,757

(22) PCT Filed: Nov. 18, 2016
(86) PCT No.: PCT/EP2016/078195

§ 371 Date: May 29, 2018

(30) Foreign Application Priority Data
Nov. 30, 2015 (FR) 1561569

(51) Int. Cl. C09K 11/02; E04C 2/54; B28B 23/00

(52) U.S. Cl. CPC C09K 11/025; E04C 2/54; C08L 101/12; B28B 23/0056; B28B 23/0037

(57) ABSTRACT

Disclosed is a luminescent insert capable of being included in a construction element, including a transparent or translucent solid matrix, and at least one luminescent material dispersed in the solid matrix, the insert defining an outer surface. The luminescent material is a colored luminescent composite pigment, made up of at least one luminescent pigment and at least one dye. Also disclosed is a construction element including at least one such luminescent insert.

The present invention relates to a luminescent insert capable of being assembled to a construction element, said insert including a transparent or translucent solid matrix, and at least one luminescent material dispersed in said solid matrix, said insert defining an outer surface.

Known, in particular from documents EP 2,716,832 and US 2010/0281802, are construction panels made from an opaque molded material, containing transparent or translucent inserts imparting transparency properties to these panels.

Also known from document EP 1,308,429 is a luminescent artificial stone capable of being used in construction.

The use of luminescent materials in construction makes it possible to provide visibility by low or nonexistent luminosity, in particular for illumination below 100 lx, or even below 10 lx or 1 lx (nighttime, shade, darkness, unlit interior due to a power outage, etc.). Preferably, good visibility is provided over a long duration, typically over several hours. This is in particular of interest for applications in signaling, for example vertical or horizontal; backup lighting, improved aesthetics of a material, for example graphic visualization, decoration, etc.

It may be desirable to obtain a different color when the material is exposed to light and when the material is in a location with little or no luminosity. To that end, it is in particular known to introduce a luminescent pigment and a dye into a same transparent matrix. This technology is in particular described in US 20050096420. However, the luminescent pigment and the dye being dispersed independently, the effect of the dye is ineffective, which requires a high dose.

There is therefore an interest in providing a luminescent insert that makes it possible to control a color when exposed to light and a luminescence under low luminosity, by limiting the amount of dye and without significantly disrupting the luminescent effect.

To that end, the invention relates to a luminescent insert of the aforementioned type, wherein the luminescent material is a colored luminescent composite pigment, made up of at least one luminescent pigment and at least one dye.

Such a colored luminescent composite pigment is in particular described in patent application FR 1,559,270, not yet published, in the Applicant's name.

Such an insert has a specific color when exposed to light, as a function of the dye, as well as a specific luminescence in darkness, as a function of the luminescent pigment. “In darkness” refers to low or nonexistent luminosity.

According to other advantageous aspects of the invention, the luminescent insert includes one or more of the following features, considered alone or according to all technically possible combinations:
the colored luminescent composite pigment has a mean particle size comprised between 50 μm and 2000 μm;
the dye has a particle size comprised between 0.1 μm and 10 μm;
the solid matrix is chosen from among polymethyl methacrylate (PMMA), polycarbonate (PC), polyvinyl chloride (PVC), polyurethane (PU), styrene acrylonitrile (SAN) copolymers, derivatives thereof such as ABS (acrylonitrile/butadiene/styrene) and glass;
a dimension of the outer surface in at least one direction is greater than or equal to 10 mm;
the outer surface has a substantially symmetrical shape relative to at least one center, axis or plane;
the outer surface substantially has a shape of revolution around an axis, more preferably a substantially cylindrical or frustoconical shape of revolution;
a height relative to the axis is greater than or equal to 1.5 times a maximum dimension of said insert perpendicular to the axis;
a height relative to the axis is smaller than a maximum dimension of said insert perpendicular to the axis;
the luminescent insert comprises at least one substantially planar end surface perpendicular to the axis;
part of the outer surface is formed by a plurality of facets separated by contours, each facet preferably being smooth and curved.

The invention further relates to an assembly for manufacturing a construction element, said assembly comprising: at least two luminescent inserts as described above, and a support capable of being assembled to said at least two luminescent inserts to keep said luminescent insert(s) in a predetermined position.

The invention further relates to an assembly for manufacturing a construction element, said assembly comprising: at least one luminescent insert as described above, said luminescent insert comprising an assembly surface that is preferably substantially planar; and a luminescent element comprising an end surface capable of being assembled to said assembly surface, said luminescent element comprising a solid, transparent or translucent matrix, and at least one luminescent material dispersed in said solid matrix.

The invention further relates to an assembly for manufacturing a construction element, said assembly comprising: at least one luminescent insert comprising a plurality of facets as described above, said luminescent insert comprising an assembly surface that is preferably substantially planar; and a coating able to cover said assembly surface so as to form an image visible through the plurality of facets of the luminescent insert.

The invention further relates to a construction element, comprising: a solid block; and at least one luminescent insert as described above, assembled to said block such that part of the outer surface of the insert forms part of an outer surface of said construction element.

According to other advantageous aspects of the invention, the construction element includes one or more of the following features, considered alone or according to all technically possible combinations:
the solid block has a base of a hardened fluid composition, preferably a composition with a hydraulic binder base;
the hydraulic binder is cement-based;
the hydraulic binder is calcium sulfate-based;
the construction element comprises at least two luminescent inserts as described above, positioned on the outer surface of said element, said two inserts having a different size and/or color;
the construction element comprises several luminescent inserts as described above, positioned on the outer surface of said element in a regular mesh, said mesh preferably being formed by several series of parallel lines, said series being inclined relative to one another;
the at least one luminescent insert includes first and second faces, preferably substantially opposite, the first face forming part of the outer surface of the element, said element further comprising a lighting device positioned across from the second face of the at least one luminescent insert;
the lighting device includes a luminescent material and/or electroluminescent device.

The invention further relates to a method for manufacturing a construction element as described above, comprising the following steps: providing a mold suitable for a hardening fluid composition; positioning, on a bottom of said mold, one or several luminescent inserts as described above, pouring a hardening fluid composition around said insert(s), so as to embed a lateral surface of said insert(s); hardening said composition to form the block; and stripping the construction element thus obtained.

According to other advantageous aspects of the invention, the method includes one or more of the following features, considered alone or according to all technically possible combinations:
the hardening fluid composition is a hydraulic binder composition; and, before the step for pouring the composition, the insert(s) are glued on the bottom of the mold using a water-soluble glue, said glue next being solubilized by the hydraulic binder before the stripping step;
the bottom of the mold is formed by a plate to which the hardening fluid composition adheres when it hardens;
the method comprises the following steps: providing a mold suitable for a hardening fluid composition; positioning, on a bottom of said mold, one or several luminescent elements; pouring a hardening fluid composition around said luminescent element(s), so as to embed a lateral surface of said luminescent element(s); hardening said composition to form the block; and assembling an end surface of said luminescent elements with luminescent inserts.
the method comprises, before the step for pouring the hardening fluid composition, a step for positioning, on a bottom of the mold, several luminescent inserts or elements, said positioning step being controlled by a computer program associating coordinates of each luminescent insert or element on the bottom of the mold with at least one visual parameter of said luminescent insert or element.

The invention will be better understood upon reading the following description, provided solely as a non-limiting example and done in reference to the drawings, in which:

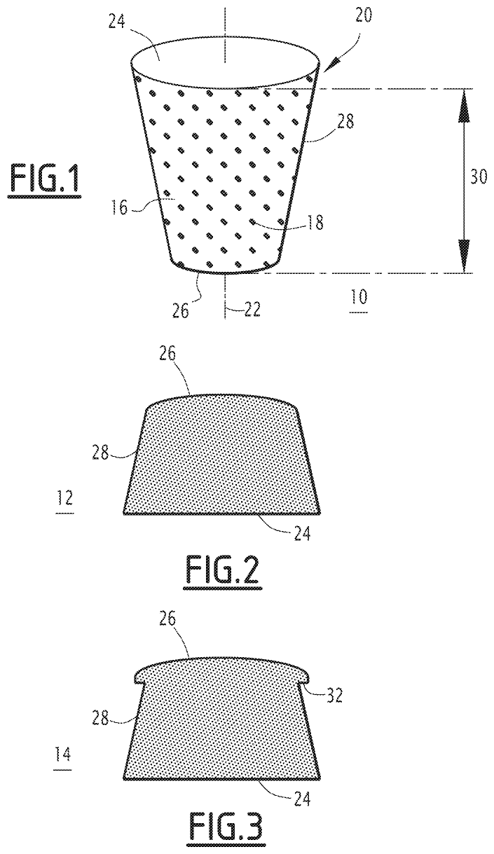

FIG. 1 shows a perspective view of an insert according to a first embodiment of the invention;

FIGS. 2 and 3 show sectional views of inserts, according to a second and third embodiment of the invention, respectively;

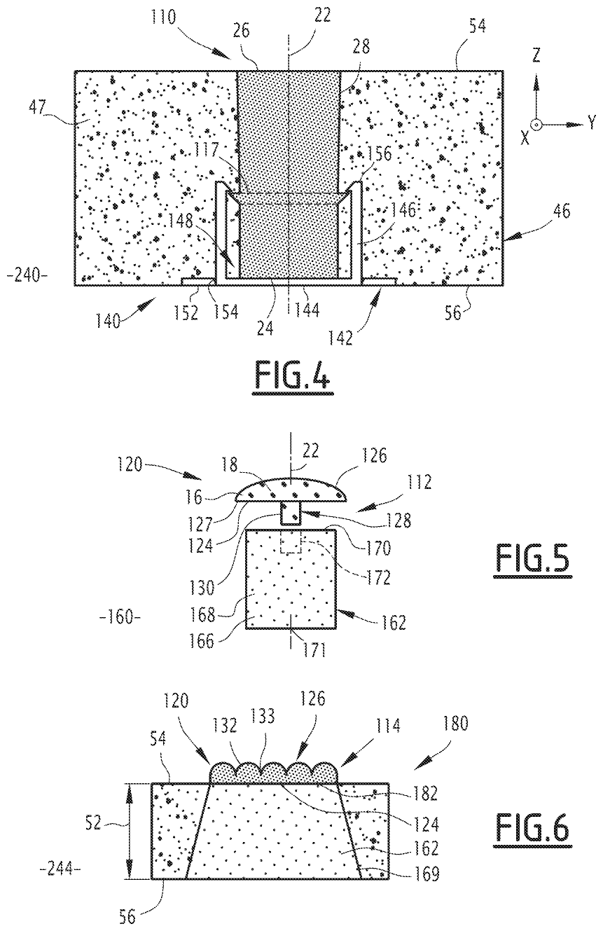

FIG. 4 shows a sectional view of a construction element comprising inserts according to another embodiment of the invention;

FIG. 5 shows an exploded view of an assembly for manufacturing a construction element, comprising an insert according to another embodiment of the invention;

FIG. 6 shows a detail sectional view of a construction element comprising inserts according to another embodiment of the invention;

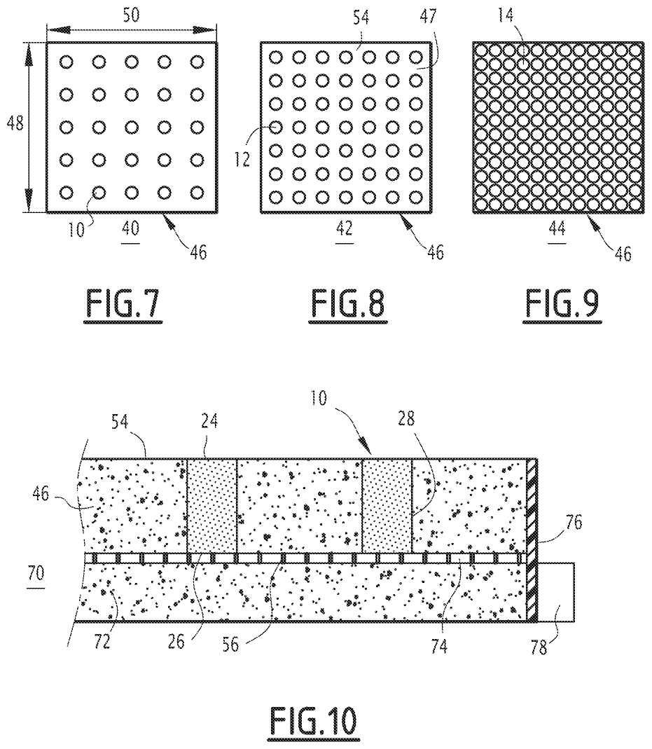

FIGS. 7-9 show front views of construction elements according to three different embodiments of the invention, comprising inserts similar to the inserts of FIGS. 1, 2 and 3, respectively;

FIG. 10 shows a partial sectional view of a construction element according to another embodiment of the invention;

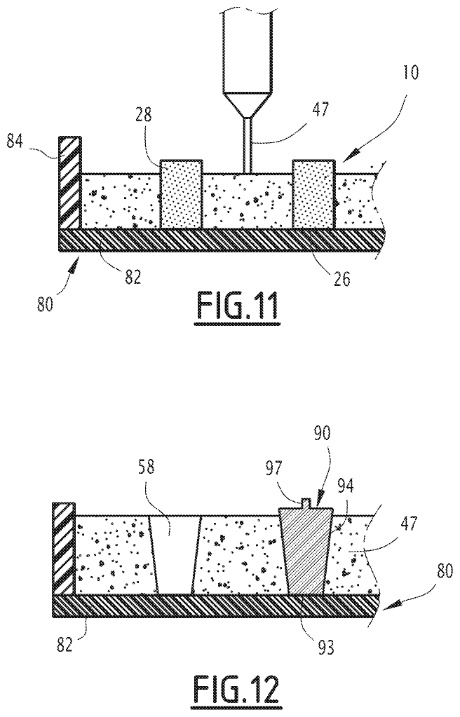

FIG. 11 shows a schematic partial sectional view of a step of a method for manufacturing the panel of FIG. 7; and

FIG. 12 shows a schematic partial sectional view of a step of another method for manufacturing the panel of FIG. 7.

FIGS. 1 to 6 show luminescent inserts 10, 12, 14, 110, 112 and 114 according to different embodiments of the invention. As shown in FIGS. 4 and 6, said inserts are able to be incorporated into construction elements 240, 244, in particular construction panels.

The insert 10, 12, 14, 110, 112, 114 comprises a transparent or translucent solid matrix 16, and at least one luminescent material 18 dispersed in said solid matrix.

The insert 10, 12, 14, 110, 112, 114 defines an outer structure 20, 120. In the embodiments of FIGS. 1 to 6, the outer surface 20 is substantially positioned along an axis 22.

Preferably, the outer surface 20, 120 has a substantially symmetrical shape relative to at least one center, axis or plane.

The inserts 10, 12, 14 and 110 of FIGS. 1 to 4 are more specifically described below. The outer surface 20 of said inserts 10, 12, 14 and 110 includes two ends surfaces 24, 26, substantially perpendicular to the axis 22, and one lateral surface 28. As will be described below, the lateral surface 28 is intended to come into contact with a hardened fluid composition 47 of the construction element.

In the embodiments of FIGS. 1 to 4, the outer surface 20 has a shape substantially of revolution around the axis 22. In particular, in the embodiments of FIGS. 1 to 3, the lateral surface 28 has a frustoconical shape. In the embodiment of FIG. 4, the lateral surface 28 has a cylindrical shape. According to alternatives that are not shown, the cone trunk or the cylinder forming the lateral surface 28 has a noncircular base, for example oval or polygonal.

If the lateral surface 28 has a frustoconical shape, an angle between the axis 22 and the generatrix of said lateral surface is preferably smaller than 20°, more preferably smaller than 10°.

Preferably, the two ends surfaces 24, 26 have a polished or smooth appearance. Preferably, the lateral surface 28 has a frosted or matte appearance.

Preferably, at least a first end surface 24 is substantially planar. In the embodiments of FIGS. 1 and 4, the two ends surfaces 24, 26 of the insert 10, 110 are planar and disc-shaped.

Alternatively, like in the embodiments 12, 14 of FIGS. 2 and 3, the second end surface 26 of the insert is curved.

Preferably, a dimension of the outer surface 20 in at least one direction is greater than or equal to 10 mm. A diameter of the end surfaces 24, 26 is for example comprised between 10 mm and 20 mm, and preferably close to 14 mm. A height 30 of the lateral surface 28 along the axis 22 is preferably 1.5 times larger than the diameter of the widest end surface 26. The height 30 is for example comprised between 25 mm and 100 mm.

In general, the inserts according to the invention may have other ratios between the height along the axis 22 and the diameters of the ends surfaces.

In the embodiments of FIGS. 1 to 4, the insert 10, 12, 14, 110 is intended to be embedded in a poured material 47 (FIG. 4) to form the construction element, as outlined below. If the lateral surface 28 has a frustoconical shape, the curved second surface 26 is preferably situated on the narrowest side of the cone trunk.

According to one alternative embodiment, the insert is intended to be inserted into a cavity of a material forming the construction panel, as outlined below. In this case, if the lateral surface 28 has a frustoconical shape, the curved second surface 26 is preferably situated on the widest side of the cone trunk. Such an embodiment may also include a shoulder 32 on the widest side of the cone trunk.

In the embodiment of FIG. 3, the outer surface 20 further includes a shoulder 32 between the lateral surface 28 and the second end surface 26. In other words, one edge of the end surface 26 has a larger diameter than the minimum diameter of the frustoconical lateral surface 28. The shoulder 32 is in the form of a ring positioned in a plane perpendicular to the axis 22.

In the embodiment of FIG. 4, the outer surface 20 of the insert 110 includes an asperity 117, in the case at hand a ring 117 positioned around the axis 22 and protruding relative to the cylindrical lateral surface 28. The ring 117 is preferably integral with the lateral surface 28.

The ring 117 preferably includes a bevel oriented toward the first end surface 24 of the insert 110.

Alternatively, the asperity 117 is a circular groove arranged in the cylindrical lateral surface 28 of the insert 110. One function of the asperity 117 will be outlined below.

The inserts 112 and 114 of FIGS. 5 and 6 are more specifically described below. The outer surface 120 of said inserts 112 and 114 includes an assembly surface 124, planar, substantially perpendicular to the axis 22. The outer surface 120 further includes an exposure surface 126, at least part of said exposure surface 126 forming a curved surface. An edge 127 separates the assembly surface 124 from the exposure surface 126. The edge 127 preferably has a circular shape, other shapes nevertheless being possible.

Preferably, the assembly surface 124 includes an asperity 128, shown in FIG. 5. The asperity 128 is for example a stud 128 protruding relative to the assembly surface 124. The stud 128 is preferably positioned along the axis 22. More preferably, a lateral surface 130 of the stud 128 includes a thread. The stud 128 is preferably integral with the assembly surface 124.

Alternatively, the asperity 128 is a cavity arranged in the assembly surface 124; said cavity is preferably positioned along the axis 22 and optionally tapped. One function of the asperity 128 will be outlined below.

In the embodiment of FIG. 5, the exposure surface 126 is smooth and curved, i.e., said surface has a curve radius with a constant sign in both dimensions perpendicular to the axis 22.

In the embodiment of FIG. 6, the exposure surface 126 is lenticular. More specifically, the exposure surface 126 is formed by a plurality of facets 132 separated by contours 133. The contours 133 mark a discontinuity in the curvature of said surface 126.

Preferably, each facet 132 is smooth and curved, forming a convex lens. Alternatively, some facets have a planar surface. One function of the facets 132 will be outlined below.

The materials 16, 18 forming the inserts 10, 12, 14, 110, 112, 114 are more specifically described below.

The transparent or translucent solid matrix 16 is preferably compatible with the alkaline pH of hydraulic binder compositions, such as concrete. More preferably, the matrix 16 is chosen from among glass, polymethyl methacrylate (PMMA), polycarbonate (PC), polyvinyl chloride (PVC), polyurethane (PU), styrene acrylonitrile (SAN) copolymers, and derivatives thereof, such as ABS (acrylonitrile/butadiene/styrene).

The luminescent material 18 is a colored luminescent composite pigment, made up of at least one luminescent pigment and at least one dye. The colored luminescent composite pigment 18 preferably has a mean particle size comprised between 50 μm and 2000 μm.

In the context of the present invention, mean particle or pellet size refers to the mean diameter of the particles. This size may be measured by volume using the laser particle size distribution for particles having a size smaller than or equal to 500 μm (standard ISO 13320:2009) or by weight by screening for particles having a size greater than 500 μm (measured according to standard NF EN 933-1 dated May 2012).

In the context of the present invention, the term “luminescent pigment” refers to any compound capable of absorbing photons emitted by the natural or artificial light and returning a light emission in case of reduced or no luminosity. Luminescence encompasses phosphorescence and fluorescence. Preferably, in the context of the present invention, the luminescent pigment is a photoluminescent pigment. T

The luminescent pigment is chosen as a function of the color, in reduced or no luminosity, which is desired. Preferably, the luminescent pigment is chosen to have a remanence of several hours after its exposure to natural or artificial light.

In general, the luminescent pigment can be organic or mineral, mineral pigments being preferred due to their greater durability, in particular in open air.

Luminescent organic pigments are in particular chosen from among naphthalimides, coumarins, xanthenes, thioxanthenes, naphtholactames, azlactones, methines, oxazines and thiazines, or mixtures thereof.

Luminescent inorganic pigments are in particular chosen from among:
sulfides, such as CaS:Bi, CaSrS:Bi, ZnS:Cu, ZnS:Pb²⁺, ZnS:Mn²⁺, ZnCdS:Cu, AB₂S₄ (where A=alkaline earth metal; B=aluminum), ZnS, ZnS:Ag, ZnS:Cu:Cl, ZnS:Cu:Al, (Ce₃(SiS₄)2X (where X=Cl, Br, I), La₃₋ₓCeₓ(SiS₄)₂I (where 0≤x≤1), SrS:Cr, SrS doped with rare earths where Mn, CdS:Mn, Y₂O₂S:(Er,Yb);
fluorides, which as AF₃ (where A=La³⁺, Ce³⁺, y³⁺) and AF₂ (Al³⁺, Mg²⁺,Ca²⁺, Pb²⁺) and containing at least one luminescent ion chosen from the group comprises trivalent metal ions (Cr³⁺, Fe³⁺, etc.) or rare earths (Y³⁺, Pr³⁺, Nd³⁺, Sm³⁺, Eu³⁺, Tb³⁺, Dy³⁺, Ho³⁺, Er³⁺, Tm³⁺, Yb³⁺), LnF₃, ALnF₄, ALn₂F₈, ALn₃F₁₀ (where Ln=rare earth or yttrium, A monovalent alkaline ion, and containing at least one luminescent ion chosen from the group made up of trivalent metal ions (Cr³⁺, Fe³⁺, etc.) or rare earths (Y³⁺, Pr³⁺, Nd³⁺, Sm³⁺, Eu³⁺, Tb³⁺, Dy³⁺, Ho³⁺, Er³⁺, Tm³⁺, Yb³⁺), EF₃ (E=Ga³⁺, In³⁺, Bi³⁺ and containing at least one luminescent ion chosen from the group made up of trivalent metal ions (Cr³⁺, Fe³⁺, etc.) or rare earths (Y³⁺, Pr³⁺, Nd³⁺, Sm³⁺, Eu³⁺, Tb³⁺, Dy³⁺, Ho³⁺, Er³⁺, Tm³⁺, Yb³⁺), Sr₁₋ₓEu²⁺ₓSiF₆.2H₂O (where 0<x≤0.5), M₁₋ₓEuₓ²⁺SiF₆ (where 0<x≤0.2 and M is in particular chosen from among calcium and barium), K₂YF₅ (doped with Gd³⁺, Tb³⁺, Eu³⁺ or Pr³⁺), LiYF₄ (doped with Gd³⁺, Tb³⁺, Eu³⁺ or Pr³⁺), NaLnF₄ (where Ln=lanthanide or Y), NaYF₄:Pr³⁺, Na(Y,Yb)F₄:Pr³⁺, Na₃AlF₆ containing at least one luminescent ion chosen from the group made up of trivalent ions (Cr³⁺, Fe³⁺, etc.) or rare earths (Y³⁺, Pr³⁺, Nd³⁺, Sm³⁺, Eu³⁺, Tb³⁺, Dy³⁺, Ho³⁺, Er³⁺, Tm³⁺, Yb³⁺), BaLiF₃:Eu³⁺, BaY₂F₈:Eu³⁺, BaSiF₆:Eu³⁺, [alpha]-NaYF₄:Pr3⁺ or LiGdF₄:Eu³⁺;
luminescent oxides such as MAl₂O₄ (where M=one or several metals chosen from among calcium, strontium and barium, the oxide being able to be doped with europium as luminescence activator and optionally being able to contain other activators such as land deign, cerium, praseodymium, neodymium, samarium, gadolinium, dysprosium, holmium, erbium, thulium, ytterbium, lutetium or tin and bismuth as co-activators like in SrAl₂O₄(Eu²⁺,Dy³⁺), (M′ₓM′_{y})Al₂O₄ (where x+y=1 and M′ and M″ are different and chosen from among calcium, strontium and barium, the oxide being able to be doped with europium as activator and optionally being able to contain other activators such as lanthanum, cerium, praseodymium, neodymium, samarium, gadolinium, dysprosium, holmium, erbium, thulium, ytterbium, lutetium or tin and bismuth as co-activators, M₁₋ₓAl₂O₄₋ₓ (where M is at least one metal chosen from among calcium, strontium and barium or wherein M comprises magnesium and at least one metal chosen from among calcium, strontium and barium, where x is not zero and preferably comprised between −0.3 and 0.6, the oxide being able to be doped with europium as activator and optionally being able to contain other activators such as lanthanum, cerium, praseodymium, neodymium, samarium, gadolinium, dysprosium, holmium, erbium, thulium, ytterbium, lutetium or tin and bismuth as co-activators, LnBO₃ where Ln=at least one rare earth, M₄Al₁₄O₂₅ where M=one or several metals chosen from among calcium, strontium and barium, the oxide being able to be doped with europium as activator and optionally being able to contain other activators, such as lanthanum, cerium, praseodymium, neodymium, samarium, gadolinium, dysprosium, holmium, erbium, thulium, ytterbium, lutetium or tin and bismuth as co-activators); Sr₄Al₁₅O₂₅; M(II)₁₋ₓEu(II)ₓM(III)ₚEu(III)_{q}Tb(III)ᵣB₉O₁₆ where M(II) is at least one bivalent metal chosen from among barium, strontium, lead and calcium, M(III) is chosen from among lanthanum, gadolinium, yttrium, cerium, lutetium and bismuth, 0≤x≤0,2, p, q and r are not zero, strictly comprised between −1 and 1 such that p+q+r=1, Ln₁₋ₓTbₓMgB₅O₁₀ where Ln=rare earth or yttrium and 0<x≤1, M₅₍₁₋ₐ₎Eu₅ₐ²⁺Si₄X₆ where M=Ba_{1-b}Sr_{b}, 0≤b≤0.1, 0≤x≤0.2 and X=Cl_{1-c}Br_{c} where 0≤c≤1, La₁₋ₓSmₓOBr (where 0<x≤0,1), ZnO:Zn, ZnO:Ga₂O₃:Bi, CaTiO₃:Pr³⁺, La₂TiOs:Pr³⁺, La₂Ti₂O₇:Pr³⁺, (La,Pr)₂Ti₂O₇, (La,Yb,Pr)₂Ti₂O₇, YBO₃:(Eu³⁺, Tb³⁺, Gd³⁺), Y₃BO₆:Eu³⁺, LnBO₃ (doped with Eu³⁺, Tb³⁺, Pr³⁺ or Tm³⁺, doped or co-doped with Ce³⁺ or Gd³⁺ and Eu³⁺, Tb³⁺, Pr³⁺, Tm³⁺ or Pr³⁺), Ln₃BO₆ (doped with Eu³⁺, Tb³⁺, Pr³⁺ or Tm³⁺, doped or co-doped with Ce³⁺ or Gd³⁺ and Eu³⁺, Tb³⁺, Pr³⁺, Tm³⁺ or Pr³⁺), Ln(BO₂)₃(doped with Eu³⁺, Tb³⁺, Pr³⁺ or Tm³⁺, doped or co-doped with Ce³⁺ or Gd³⁺ and Eu³⁺, Tb³⁺, Pr³⁺, Tm³⁺ or Pr³⁺), SiO₂ (doped with rare earths), SiO₂:(Sm³⁺, Al³⁺), Al_{(2-x-y)}(Y,Ln)ₓO₃:yM (where M=Cr₂O₃, V₂O₅, NiO, WO₃, CuO, FeO, Fe₂O₃ and Ln=Er, La, Yb, Sm, Gd and mixtures thereof and 0.48≤x≤1.51 and 0.007≤y≤0.2), Al₂O₃ (doped with rare earths),
phosphate glasses (doped with rare earths), LiNbO₃ (doped with rare earths), TiO₂ (doped with rare earths), LaPO₄:Ce and/or Tb, LaPO₄:Eu, CePO₄:Tb, MAl₂B₂O₇:Eu²⁺ (where M=Sr, Ca), M₂B₅O₉X:Eu (where M=Ca, Sr, Ba and X=Cl, Br), CaSO₄:Eu, CaSO₄:Eu, LaMgB₅O₁₀:Ce where Mn, Y₂O₃:Eu, Gd₂O₃:Eu, (Y_{0.7}Gd_{0.3})₂O₃:Eu, CoAl₂O₄, Mg₄GeO₅.5F:Mn, (Sr,Mg)₃(PO₄)₂:Sn, Y3Al5O12:Ce, BaMgAl₁₀O₁₇:Eu, BaMg₂Al₁₆O₂₇:Eu, (Ce,Tb)MgAl₁₁O₁₉, (Ce,Gd,Tb)MgB₅O₁₀, (Ce,Gd,Tb)MgB₅O₁₀:Mn, LaPO₄:(Ce,Tb), Sr₂Al₁₄O₂₅:Eu, Ca₅(PO₄)₃(F,Cl):(Sb,Mn), (La,Ce,Tb)(PO₄)₃:(Ce,Tb), CeO_{0.65}TbO_{0.35}MgA₁₁O₁₉, barium-titanium phosphates, (Ba,Sr,Ca)₂SiO₄:Eu, SrAl₁₂O₁₉:Ce, BaSi₂O₅:Pb, (Sr,Zn)MgSi₂O₇:Pb, SrB₄O₇:Eu, (Gd,La)B₃O₆:Bi, Sr₂P₂O₇:Eu, BaMgAl₁₀O₁₇:Eu, Mn, Zn₂SiO₄:Mn, YVO₄:(Eu,Sm,Dy), AWO₄ (where A=Ca, Ba, Pb, Cd, Zn, Mg), In₂O₃:(Er,Tb), GdAl(BO₃)₄:Nd, ZrO₂:Eu³⁺, GdVO₄:(Bi,Eu);
red phosphate; and
alkaline metal or alkaline earth nitrites.

Preferably, the luminescent pigment is chosen from among zinc sulfide and strontium or calcium aluminates doped with rare earths, or mixtures thereof. More preferably, the luminescent pigment is chosen from among zinc sulfide and strontium aluminates doped with rare earths.

Preferably, the luminescent pigment is not covered with a protective layer, i.e., it is not covered with a polymeric matrix (for example, polyethylene) or a wax seeking to protect them from outside attacks, in particular reactions with respect to water. Indeed, as shown by the inventors, if luminescent pigments pretreated and covered with a protective layer are used in the context of the invention, when the obtained composite pigment is washed with water, the water is colored the color of the dye, therefore showing leaching of the dye. This also makes it possible to show that there is indeed a close association between the luminescent pigment and dye in the colored luminescent composite pigment.

Preferably, the luminescent pigment has a mean particle size comprised between about 60 and about 2000 μm, preferably between about 60 and about 500 μm, for example between about 75 and about 200 am.

Preferably, the luminescent pigment particles are porous and have a percentage of pores by volume, in particular measured with mercury according to standard ISO 15901-1:2005, comprised between 1 and 90%, preferably between about 2 and about 50%.

In the context of the present invention, “dye” refers to a substance, or a mixture of substances, making it possible, when used in a material, to impart a color to this material by absorbing or reflecting radiations with specific wavelengths. This substance, or this mixture, can be soluble or insoluble in the material in question.

In the context of the present invention, the dye makes it possible to fix the color of the material to the light, in particular to the daylight. The dye is chosen as a function of the desired color in the daylight. Thus, for the colored luminescent composite pigment, it is possible to have a daytime color-derived from the dye-different from the nighttime color derived from the luminescent pigment. It is also possible to use mixtures of dyes.

The dye can be organic or inorganic. The dye may in particular assume the form of a powder or a suspension.

Organic dyes may in particular be chosen from among nitroso (compound comprising a NO group), nitro (compound comprising a NO₂ group), azo (compound comprising a HN=NH group), xanthene, quinoline, anthraquinone, phthalocyanine, metal complex type, isoindolinone, isoindoline, quinacridone, perinone, perylene, diketopyrrolopyrrole, thioindigo, dioxazine, triphenylmethane, quinophthalone compounds. These dyes are known by those skilled in the art. These dyes may also be in the form of composite dyes as described for example in patent EP 1,184,426. These composite dyes may in particular be made up of particles including an inorganic core, at least one binder ensuring fixing of the organic dyes on the core, and at least one organic dye covering the core at least partially.

The dye may also be a dye with special effects. Dyes with special effects refer to dyes that generally create a colored appearance (characterized by a certain shade, a certain vivacity and a certain clarity) that is not uniform and changes as a function of the viewing conditions (light, temperature, viewing angles, etc.). They are thereby in contrast to white or colored dyes that procure an opaque, semi-transparent or traditional transparent uniform hue. Pigments with special effects include nacred pigments such as white nacred pigments such as titanium mica, or bismuth oxychloride mica, colored nacred pigments such as titanium mica with iron oxides, titanium mica in particular with ferrous blue or chromium oxide, titanium mica with an organic pigment of the aforementioned type as well as nacred pigments with a base of bismuth oxychloride.

Inorganic dyes include titanium oxides such as anatase and rutile, the various iron oxides (yellow, red, brown, etc.), chromium oxides, barium oxides, cadmium oxides, nickel oxides, copper oxides, cobalt oxides, zinc oxides, cobalt stannate, cobalt aluminates, quartz powder, talc, carbon black, calcium carbonate and barium sulfate.

The dye may also be a fluorescent dye (or whitening agent). Such fluorescent dyes may be interesting, in particular for safety displays. The effect of the dye may be reinforced by combination with an optical whitening agent, for example. This whitening agent (or combination of whitening agents) may for example the chosen from among stilbene derivatives. Advantageously, the addition of a fluorescent dye or an optical whitening agent also makes it possible to modulate the nighttime color of the luminescent pigment.

Preferably, in the context of the invention, the dye is chosen from among iron, barium, chromium, cadmium, zinc, cobalt, nickel and titanium oxides and carbon black.

Preferably, in the context of the present invention, for non-soluble dyes, the size of the dye particles is smaller than the size of the luminescent pigment particles. Preferably, the mean size of the dye particles is at least 10 times smaller than that of the luminescent pigment. Preferably, the dye has a mean particle size comprised between about 0.1 μm and about 10 μm.

A method for preparing the colored luminescent composite pigment 18 is described in application FR 1,559,270, in the Applicant's name.

The matrix 16 may further contain elements making it possible to modify the optical properties of the material, such as glass beads or flakes making it possible to obtain either additional optical effects, such as flickering or retro-reflection, or to modify the density of the insert.

A first step of a method for manufacturing an insert 10, 12, 14, 110, 112, 114 includes the dispersion of the pigment 18 in a solution capable of generating the solid matrix 16, in particular by solidification, cross-linking or polymerization.

A second step of said method includes molding, rotational molding, injection or extrusion of the obtained liquid composition. For example, a mold having a shape complementary to the outer surface 20, 120 is provided. In the case of the embodiments of FIGS. 4, 5 and 6, respectively, the mold in particular provides the shape of the ring 117, the threaded stud 128 or the facets 130.

Said mold is next filled, for example by an injection press. After solidification, cross-linking or polymerization of the composition, then stripping, the insert 10, 12, 14, 110, 112, 114 is obtained.

FIG. 4 shows a first assembly 140 for manufacturing a construction element 240. Said construction element will be outlined below.

The first assembly 140 includes at least one insert 110, and preferably several inserts 110, as described above. The first assembly 140 further includes a support 142.

The support 142 is capable of being assembled to the insert(s) 110 to keep said insert(s) in a predetermined position.

An orthonormal coordinate system (X, Y, Z) is considered, the direction Z being parallel to the axis 22 of the insert 110. In the following description, the direction Z is considered to represent the vertical.

In the embodiment of FIG. 4, the support 142 is an elongated strip, essentially positioned along the direction X. Preferably, like in the embodiment of FIG. 4, the support 142 is substantially symmetrical in two planes (X, Z) and (Y, Z).

The strip 142 of FIG. 4 includes a substantially planar base 144, positioned in a plane (X, Y). The strip 142 further includes a plurality of sleeves 146 protruding along Z the relative to the base 144. The sleeves 146, substantially identical, are positioned along X along said base 144.

In the embodiment of FIG. 4, each sleeve 146 has a substantially cylindrical shape of revolution along an axis parallel to Z. The cutting plane of FIG. 4 passes through said axis of revolution of a sleeve 146.

Each sleeve 146 defines a cell 148 capable of receiving part of an insert 110. In the embodiment of FIG. 4, a diameter of the cell 148 is slightly larger than a diameter of the first end surface 24 of the insert 110.

On either side of the sleeves 146, the base 144 includes fins 152. As an example, a total width along Y of the base 144, including the fins 152, is comprised between 1.5 and 2.5 times an outer diameter of the sleeves 146.

Optionally, the base 144 includes slots 154 tangent to the sleeves 146 and forming an edge of each fin 152. The fins 152 are thus sectile relative to the rest of the strip 142, by bending at said slot 154.

An end along Z of the sleeve 146, opposite the base 144, includes a radial protrusion 156 oriented toward the inside of said sleeve.

The radial protrusion 156 is configured so as to cooperate with the asperity 117 of the insert 110, in order to assemble said insert 110 with the cell 148 by clipping by coming together along the direction Z.

The radial protrusion is for example formed by a plurality of notches, positioned in a plane (X, Y) and forming a discontinuous ring 156 on an inner wall of the sleeve 146. An inner diameter of said discontinuous ring is slightly larger than the diameter of the first end surface 24 of the insert 110.

The protrusion 156 preferably includes a bevel oriented upward, to facilitate the clipping with the ring 117 of the insert 110 as described above.

A method for assembling the assembly 140 will now be described. The first end surface 24 of the or each insert 110 is positioned at the discontinuous ring 156. Said end surface 24 is next brought closer, along Z, to the base 144 of the support 142. The beveled surfaces of the ring 117 and the discontinuous ring 156 slide against one another and facilitate the assembly of the insert 110 in the cell 148 by resilient nesting or by clipping. When the ring 117 is positioned in said cell 148, non-beveled surfaces of the ring 117 and the discontinuous ring 156 form a stop along Z, preventing the separation of the insert 110 and the support 142.

Preferably, the assembly 140 includes at least two inserts 110, or a plurality of inserts 110, able to be assembled to the support 142 so as to be aligned along the axis X. Said inserts 110 of the assembly 140 are identical or different. For example, the inserts 110 of a same assembly 140 include colored luminescent composite pigments 18 of different colors, or different concentrations of said pigments 18 in the matrix 16.

As an alternative to the embodiment described above, the support 142 is able to be assembled to a plurality of inserts 110 bidirectionally. For example, the cells 148 are positioned in several series of parallel lines, said series being inclined relative to one another in a plane (X, Y).

As an alternative to the embodiment described above, the inserts 110 of the assembly 140 do not include an asperity 117 of the ring or groove type, and the sleeves 146 are configured so as to be inserted forcibly around said inserts.

The inserts 110 are thus kept in place by the support 142 during the manufacture of the construction element 240 by pouring a hardening fluid composition. Such a manufacturing method will be outlined below.

FIG. 5 shows a second assembly 160 for manufacturing a construction element. The second assembly 160 includes an insert 112 as described above, as well as a luminescent element 162.

The luminescent element 162 for example comprises a transparent or translucent solid matrix 166, similar to the matrix 16, and at least one luminescent material 168 dispersed in said solid matrix. Said luminescent material 168 is preferably a luminescent pigment of the type described above, said luminescent pigment not being associated with the dye, unlike the colored luminescent composite pigment 18.

The luminescent element 162 therefore has a colorless or slightly colored translucent appearance. In particular, the luminescence of said element 162 is preferably white.

The luminescent element 162 preferably has a shape similar to that of the insert 10 or 110 described above, with a lateral surface 169, preferably cylindrical or frustoconical of revolution, and two end faces 170, 171, preferably planar.

A first end face 170 of the luminescent element 162 includes an asperity 172 capable of cooperating with the asperity 128 of the insert 112 to assemble said insert 112 with said luminescent element 162. Preferably, said assembly is reversible.

In particular, when the asperity 128 of the insert 112 is the threaded stud described above, the asperity 172 of the luminescent element 162 is for example a tapped cavity capable of being assembled by screwing to said threaded stud.

FIG. 6 shows a third assembly 180 for manufacturing a construction element. The third assembly 180 includes an insert 114 as described above, as well as a coating 182 able to cover the assembly surface 124.

Preferably, the coating 182 forms an image on the assembly surface 124. The coating 182 is for example a translucent plastic film, printed and glued on said surface 124. For a viewer situated on the side of the exposure surface 126 made up of lenses 132, the visible section of the coating 182 depends on the angle from which the image is viewed. It is thus possible to break down from 2 to 100 images, preferably from 5 to 70 images, to give the impression of movement when the viewer moves.

Preferably, as shown in FIG. 6, the third assembly 180 further comprises a luminescent element 162 as described above, capable of being assembled reversibly to the assembly surface 124 of the insert 114. When such an assembly 180 is assembled, the coating 182 is sandwiched between said assembly surface 124 and the first end face 170 of the luminescent element 162.

The luminescent element 162 in particular makes it possible to reinforce the visibility of the insert 112, 114 in darkness, by imparting backlighting to said insert through its own luminescence.

Alternatively, the embodiment of FIG. 4 is combined with the embodiment of FIG. 5 and/or FIG. 6: the inserts 110 of the assembly 140 are replaced by luminescent elements 162 with a similar shape, said luminescent elements being capable of being assembled to inserts 112 and/or 114 as described above.

FIGS. 4, 6 and 7-9 show construction elements 240, 244, 40, 42, 44, respectively, according to embodiments of the invention.

The construction element 240, shown in sectional view in FIG. 4, comprises a manufacturing assembly 140 as described above, said assembly comprising a plurality of inserts 110 and a support 142.

The construction element 244, shown in sectional view in FIG. 6, comprises a plurality of manufacturing assemblies 160 and/or 180 as described above. FIG. 6 shows a detailed view of the assembly 180 described above, comprising an insert 114, a coating 182 and a luminescent element 162 that are assembled in the manner described above.

The construction elements 40, 42, 44 of FIGS. 7 to 9 are construction panels comprising inserts 10, 12, 14, respectively, as described above.

Each of the construction elements 40, 42, 44, 240, 244 includes a block 46 made with a base of a material 47. According to one preferred embodiment, said material 47 is a hardened fluid composition. According to one alternative, the material 47 is a solid material of the wood or stone type.

The hardened fluid composition 47 is for example: a plastic; a bituminous material such as an asphalt; a polymeric concrete combining a resin-based binder with natural particles as used to produce a stone carpet; or preferably, a hydraulic binder-based composition such as a plaster or a concrete.

“Hydraulic binder” refers to any compound having the property of hydrating in the presence of water and whose hydration makes it possible to obtain a solid having mechanical characteristics.

The hydraulic binder-based position comprises at least water and at least a hydraulic binder. It may also contain pellets, as well as additives such as anti-foaming agents, air-entraining agents or dyes.

The hydraulic binder may comprise or consist of a cement according to standard EN 197-1, and in particular a cement of type CEM I, CEM II, CEM III, CEM IV or CEM V according to Cement standard NF EN 197-1 (2012). The cement may therefore in particular comprise mineral additions.

The hydraulic binder may also comprise a calcium aluminate cement as defined in standard EN 14647 (2006) or a sulfoaluminous cement.

The hydraulic binder may also be a calcium sulfate-based hydraulic binder. The expression “calcium sulfate-based aluminum binders” refers, according to the invention, to partially or completely anhydrous calcium sulfate-based hydraulic binders. This in particular comprises:
Gypsum or hydrated calcium sulfate: CaSO₄.2(H₂O);
Semi-hydrated calcium sulfate or hemi-hydrated calcium sulfate or partially anhydrous calcium sulfate; CaSO₄0.5H₂O;
Anhydrous calcium sulfate or anhydrite or completely anhydrous calcium sulfate: CaSO₄.

The block 46 is preferably in the shape of a rhomb, with a length 48, a width 50 and a thickness 52. The thickness 52 is defined by the distance between a first 54 and a second 56 main face of the block 46.

In the embodiments of FIGS. 6 to 9, the block 46 is in the form of a slab, the length 48 and the width 50 being significantly greater than the thickness 52. For example, the length 48 and the width 50 are about 200 mm and the thickness 52 is about 25 mm. The block 46 therefore includes two square main faces 54, 56. Alternatively, the main faces 54, 56 of the block 46 are rectangular or in the form of a regular polygon, such as a triangle or a hexagon.

In the embodiment shown in FIG. 4, the length of the block 46, positioned along the direction X, is significantly larger than the thickness, and preferably than the width, of said block. The construction element 240 is in particular in the form of a beam. For example, the thickness is comprised between several centimeters and several tens of centimeters; the length and the width are comprised between several tens of centimeters and several meters.

Part of the outer surface 20, 120 of the inserts forms part of an outer surface of the panel 40, 42, 44, 240, 244. The inserts 10, 12, 14, 110 are incorporated into the block 46 of the panel 40, 42, 44, 240. An end surface 24 or 26 of the insert 10, and the second end surface 26 of the insert 12, 14, 110, is flush with the first face 54 of the panel 40, 42, 44, 240.

In the case of the beam 240, the support 142 is also embedded in the block 46. Optionally, the base 144 is flush with the second face 56 of said block.

In the case of the panel 244, the luminescent element 162 is incorporated in the block 46 and the first end surface 170 is flush with the first face 54. The insert 114 covers the first end surface 170 to which it is assembled.

Preferably, the inserts 10, 12, 14, 110, 114 are positioned relative to the block 46 such that the axis 22 of each insert is parallel to the direction of the thickness 52.

In order to simplify this description, all of the inserts of a same panel 40, 42, 44 are of the same type 10, 12 or 14. However, in general, a same construction element may include several inserts of different types or several manufacturing assemblies 160 or 180 of different types.

Preferably, all of the inserts 10, 12, 14, 110 of a same construction element have substantially a same height 30 of the lateral surface 28 along the axis 22. However, as described below, certain inserts 10, 12, 14 of a same panel 40, 42, 44 preferably have different end surface 24, 26 diameters.

Likewise, certain inserts of a same construction element preferably include colored luminescent composite pigments 18 of different colors, or different concentrations of said pigments 18 in the matrix 16.

The visible surfaces of said inserts of a same construction element thus have a different visual appearance, in particular a different size and/or color. The assembly of the inserts of a same construction element, or of several juxtaposed elements, can thus form a determined image.

Preferably, the inserts 10, 12, 14, 110, 112, 114 are positioned in a regular mesh on the first face 54 of the block 46. In the case of the beam 240, the inserts 110 are positioned unidirectionally along X, along the support 142. Alternatively, the beam 240 may include several assemblies 140, for example positioned in parallel, forming several rows of visible surfaces 26 on the first face 54 of the block 46.

Alternatively, in particular for the panel-type elements, the mesh is preferably formed by several series of parallel lines, said series being inclined relative to one another.

For example, in FIGS. 7 to 9, the mesh is formed by two series of parallel lines, said series being perpendicular to one another and respectively positioned along the directions of the length 48 and the width 50 of the block 46. As a non-limiting alternative, the mesh is formed by three series of parallel lines, said series being inclined by 60° relative to one another.

FIGS. 7 to 9 show several examples of insert densities in the panels 40, 42, 44. For example, the panel 40 includes 25 inserts for dimensions of 200×200 mm of the face 54, or a density of 625 inserts/m². For similar dimensions, the panels 42 and 44 respectively have densities of 1225 and 3600 inserts/m². Such densities are applicable irrespective of the type of insert 10, 12, 14.

Significantly higher insert densities may also be used. However, in order to facilitate the manufacturing of the panels as described below, it is preferable to maintain, between the inserts 10, 12, 14 of a same panel, or between the luminescent elements 162 of a same panel, a distance of at least 2 mm, preferably of at least 4 mm.

According to one embodiment, the hardened fluid composition 47 includes pellets, as for example described in application FR 1,559,270. In this case, the insert density in the construction elements is chosen such that a minimum distance between two inserts 10, 12, 14 is greater than a maximum dimension of the pellets, and preferably five times, or even ten times greater than said maximum dimension.

According to one embodiment of the invention, the thickness 52 of the block 46 is greater than the height 30 of the insert 10, 12, 14 along the axis 22. Only the second end surface 26 of the insert 10, 12, 14 is flush with a face 54 of the panel 40, 42, 44, the other of said end surfaces being embedded in the block 46.

According to one alternative embodiment, the thickness 52 of the block 46 is substantially equal to the height 30 of the insert. Each of the two end surfaces 24, 26 of the insert is flush with a face 54, 56 of the panel.

FIG. 10 shows a construction panel 70 comprising a first block 46 and a second block 72, superimposed on one another along the thickness of said panel 70. Optionally, the first 46 and second 72 blocks are formed from a same material 47.

Inserts 10 are incorporated into the first block 46, each of the two end surfaces 24, 26 being flush with a face 54, 56 of said first block 46. The first face 54 of the first block 46 and the first end surfaces 24 of the inserts 10 form part of the outer surface of the panel 70.

The inserts 10 can be positioned bidirectionally, like in the panels 40, 42, 44, or unidirectionally, like in the beam 240.

The panel 70 further includes a web 74 of light-emitting diodes (LEDs), sandwiched between the first 46 and second 72 blocks. The LEDs are in contact with the second face 56 of the first block 46 and second end surfaces 26 of the inserts 10.

Similarly to the inserts 10, the LEDs of the web 74 can be positioned bidirectionally, or unidirectionally.

The LED web 74 forms a lighting device making it possible to backlight the inserts 10. Preferably, the LED web 74 is connected to an electrical power source, for example a solar panel 76 or a battery.

According to one body, the construction panel 70 further includes an electronic device 78 for controlling the lighting of the LEDs 74 in order to control the lighting independently of each insert 10 or different groups of inserts 10. It is thus possible to create animated images by varying the lighting of the different inserts of the panel 70 over time.

According to one embodiment, the LED web is removable, for example to facilitate the maintenance thereof. In this case, the first 46 and second 72 blocks are preferably separable from one another.

According to one alternative embodiment, the panel 70 does not include a second block 72, the web 74 of LEDs being accessible by the face opposite the first face 54 of the block 46.

The LED web 74 can be replaced by another light-emitting device, i.e., another device capable of converting electrical energy into light.

As an alternative to the embodiment described above, the inserts 10 are replaced by luminescent elements 162 of manufacturing assemblies 160 or 180 described above. Each of the two ends surfaces 170, 171 is flush with a face 54, 56 of the first block 46 and an insert 112, 114 is assembled to each luminescent element 162 on the side of the first face 54.

A first method for manufacturing the panel 40 of FIG. 7 will now be described, using FIG. 11. Said method first comprises providing a mold 80 with a shape substantially complementary to the outer shape of the block 46. The mold 80 is preferably a casting mold, including a bottom 82 and a side wall 84.

In the example described here, the composition 47 forming the block 46 is a hydraulic binder composition such as a concrete; the mold 80 is suitable for such a composition.

In a following step of the method, the inserts 10 are deposited on the bottom 82 of the mold, according to the desired mesh. The deposition of the inserts 10 is preferably done using an automaton, said automaton being controlled by a computer program.

In particular, the coordinates of each insert 10 on the mesh are associated with at least one particular visual parameter of the insert 10. The visual parameter is for example the color of the insert 10 when exposed to light and/or the luminescence of the insert 10 in darkness. Such parameters in particular depend on the nature of the luminescent material 18, in particular the dye and the luminescent pigment that make up the colored luminescent composite pigment 18. These parameters also depend on the concentration of the luminescent material 18 in the matrix 16.

The visual parameter may also be the diameter of the at least one end surface 24, 26 that will be visible.

Preferably, the program matches the coordinates of each insert 10 with a specific size and/or color and/or luminescence, such that the inserts 10 positioned on the mesh form a predetermined image. The image can be different when exposed to light—the colors of the dyes being visible—and in darkness—the luminescences of the luminescent pigments being visible.

It is preferable to implement a system making it possible to keep the inserts 10 in place during the placement of the fluid composition forming the block 46. For example, the first end surface 24 of the inserts 10 is glued on the bottom 82 of the mold using a water-soluble glue, then the glue is allowed to dry for the necessary time. Alternatively, an adhesive film is used.

According to one particular embodiment, before the placement of the inserts 10, the bottom 82 of the mold is coated with a formulation intended to produce deactivated concretes. Such formulations slow the setting of the concrete on the surface to obtain a particular aesthetic effect. Certain formulations of this type also make it possible to cause the inserts 10 to adhere on the bottom 82 of the mold. Appropriate formulations are for example marketed under the names CHRYSO® Deco Lav P, CHRYSO® Deco Lav N, CHRYSO® Revello Isy D or CHRYSO® Deco Wash, or described in document FR 2,991,982.

Next, a fluid hydraulic binder-based composition 47 is poured around said inserts 10, as shown in FIG. 10, so as to embed their lateral surface 28. Depending on the selected embodiment, the quantity of composition 47 is calculated so as to leave the second end surface 26 visible, or to embed said second surface in the block 46.

During the hardening of the composition 47 to form the block 46, the water of the composition dissolves the glue that fixes the inserts 10 to the bottom 82. The panel 40 obtained after complete hardening is thus easily stripped.

According to one alternative embodiment, the bottom 82 of the mold is formed by a plate to which the composition 47 adheres when it hardens. Said plate 82 is thus secured to the block 46 to form the panel 40. During stripping, only the lateral wall 84 of the mold is removed. According to this alternative, the inserts 10 can be glued on the bottom 82 by an insoluble glue.

If the inserts 10 have a frustoconical lateral surface 28 and one of the end surfaces 24, 26 is embedded in the block 46, it is preferable for the visible end surface 24 to be that with the smallest diameter. Thus, the stripping of the insert 10 is avoided in case of different expansions between the block 46 and the matrix 16. In the methods described above, the inserts 10 are therefore preferably positioned accordingly.

The panels 42, 44 are obtained similarly to the method above, by replacing the inserts 10 with the inserts 12, 14. The quantity of composition 47 is calculated so as to leave the curved second end surface 26 visible. In the case of the insert 14, the quantity of composition 47 is calculated so as to be flush with the shoulder 32.

According to a second method for manufacturing the panel 40, the composition 47 is poured in the mold 80 before the positioning of the inserts 10. Before hardening of said composition 47, the inserts 10 are assembled by studding to said composition, i.e., they are driven into said composition 47 during hardening. Guide devices of the template type, placed above the first surface 54, allow regular positioning of the inserts.

A third method for manufacturing the panel 40 will now be described, using FIG. 12. According to said method, in the step for deposition on the bottom 82 of the mold 80, the inserts 10 are replaced by molding studs 90. The molding studs 90 include a bottom 93 and a lateral surface 94 with a shape substantially identical to the lateral surface 28 of the inserts 10. Preferably, the molding studs 90 also include an upper face equipped with a gripping element 97.

Next, a fluid hydraulic binder composition 47 is poured around the studs 90, so as to embed their lateral surfaces. As shown in FIG. 11, the quantity of composition 47 is calculated so as to leave the upper face of the studs visible.

After hardening of the composition 47, the studs 90 are removed by pulling on the gripping elements 97, leaving cavities 58 thus formed in the block 46 free.

Inserts 10 are introduced into the cavities 58 according to the desired mesh for the panel 40. As previously described, the diameters, colors and luminescences of the inserts of a same panel can be different, depending on the desired visual effect when exposed to light and/or in darkness.

It is possible to fasten the inserts 10 to the cavities 58, for example using a glue.

The third manufacturing method described above in particular makes it possible to produce the blocks 46 in series and to subsequently customize the image shown on each panel, by choosing the color and/or the luminescence of each insert 10. It is also possible to replace one or several of said inserts during use of the panel to modify said image.

As an alternative to said third manufacturing method, the inserts 10 are replaced by inserts of type 12, 14 with a curved end surface 26. However, when the lateral surface 28 is frustoconical, said curved surface 26 is preferably situated on the widest side of the cone trunk in order for the insert 12, 14 to be able to be introduced into the cavity 58.

According to a fourth method for manufacturing the panel 40, cavities 58 are made by piercing a block 46 made from a solid material 47, then the inserts 10 are introduced and optionally fastened in said cavities. Such a manufacturing method thus makes it possible to implement a block 46 formed from a material 47 that is not necessarily derived from a hardened fluid composition. This material is for example wood, stone, or a metal or synthetic material whose melting temperatures are not compatible with the matrix 16.

A method for manufacturing the panel 244 will now be described. Similarly to the method described above with the inserts 10, luminescent elements 162 are deposited on the bottom 82 of the mold 80, according to the desired mesh. Next, a fluid hydraulic binder composition 47 is poured around said luminescent elements 162 so as to embed their lateral surface 28.

According to a first embodiment, the first end surface 170 of said elements 162 is oriented toward the bottom of the mold. According to another embodiment, the second end surface 171 is in contact with said bottom and the quantity of composition 47 is calculated so as to leave the first end surface 170 visible. After hardening of the composition 47, the inserts 112 and/or 114 are assembled to said first end surfaces 170. As described above, the assemblies are preferably removable, so as to be able to change said inserts at will. The image formed on the surface of the panel 244 can thus be modified easily.

A method for manufacturing the construction element 240 will now be described. Multiple inserts 110 are assembled to a support 142 in order to form a manufacturing assembly 140 as described above, the inserts being kept in a predetermined position by the support 142.

Said manufacturing assembly 140 is placed in a mold with an appropriate shape. In the embodiment of FIG. 4, the base 144 of the support 142 is in contact with the bottom of the mold. Optionally, the fins 152 are removed beforehand from the rest of the support.

A fluid hydraulic binder composition 47 is next poured in the mold, so as to leave the end surfaces 26 of the inserts 110 visible. The support 142 is embedded in said composition 47.

The inserts 110 are thus kept in place by the support 142 during the pouring of the composition 47, which in particular authorizes greater pouring speeds.

According to one alternative, several supports 142 assembled to inserts 110 are in turn assembled to one another before pouring the composition 47, to form an assembly 140 with larger dimensions.

According to one alternative embodiment of the construction element 240, the inserts 110 of the assembly 140 are replaced by luminescent elements 162 of similar shape and, after hardening of the composition 47, inserts 112 and/or 114 are assembled to the first end surfaces 170 of said luminescent elements 162.

After manufacturing of the construction elements 40, 42, 44, 70, 240, 244, several identical or different construction elements can be juxtaposed to form an image with larger dimensions. The juxtaposition can be done in two dimensions, in particular to produce a panel with large dimensions. The juxtaposition can also be unidimensional; for example, beams 240 are aligned along X, for example to form a road signaling element.

The assembled construction elements thus form a decorative and/or signaling element, which can have a different appearance when exposed to light and in darkness. As an example, assembled panels form a first inscription visible when exposed to light and a second, different inscription visible in darkness.

1. A luminescent insert capable of being assembled to a construction element, said insert comprising a transparent or translucent solid matrix, and at least one luminescent material dispersed in said solid matrix, said insert defining an outer surface,
wherein the luminescent material is a colored luminescent composite pigment, made up of at least one luminescent pigment and at least one dye.

2. The luminescent insert according to claim 1, wherein the outer surface has a substantially symmetrical shape relative to at least one center, axis or plane.

3. The luminescent insert according to claim 2, wherein the outer surface substantially has a shape of revolution around an axis, more preferably a substantially cylindrical or frustoconical shape of revolution.

4. The luminescent insert according to claim 1, wherein a part of the outer surface is formed by a plurality of facets separated by contours, each facet preferably being smooth and curved.

5. An assembly for manufacturing a construction element, said assembly comprising:
at least two luminescent inserts according to claim 1, and
a support capable of being assembled to said at least two luminescent inserts to keep said luminescent insert(s) in a predetermined position.

6. An assembly for manufacturing a construction element, said assembly comprising:
at least one luminescent inserts according to claim 1, said luminescent insert comprising an assembly surface that is preferably substantially planar; and
a luminescent element comprising an end surface capable of being assembled to said assembly surface, said luminescent element comprising a solid, transparent or translucent matrix, and at least one luminescent material dispersed in said solid matrix.

7. An assembly for manufacturing a construction element, said assembly comprising:
at least one luminescent insert according to claim 4, said luminescent insert comprising an assembly surface that is preferably substantially planar; and
a coating able to cover said assembly surface so as to form an image visible through the plurality of facets of the luminescent insert.

8. A construction element, comprising: a solid block; and at least one luminescent insert according to claim 1, assembled to said block such that part of the outer surface of the insert forms part of an outer surface of said element.

9. The construction element according to claim 8, wherein the solid block has a base of a hardened fluid composition, preferably a composition with a hydraulic binder base.

10. The construction element according to claim 8, comprising at least two luminescent inserts according to claim 8, positioned on the outer surface of said element, said two inserts having a different size and/or color.

11. The construction element according to claim 8, wherein the at least one luminescent insert includes first and second faces, preferably substantially opposite, the first face forming part of the outer surface of the element, said element further comprising a lighting device positioned across from the second face of the at least one luminescent insert.

12. The construction element according to claim 11, wherein the lighting device includes a luminescent material and/or electroluminescent device.

13. A method for manufacturing a construction element according to claim 8, comprising the following steps:
providing a mold suitable for a hardening fluid composition,
positioning, on a bottom of said mold, one or several luminescent inserts according to claim 8,
pouring a hardening fluid composition around said insert(s), so as to embed a lateral surface of said insert(s),
hardening said composition to form the block; and
stripping the construction element thus obtained.

14. A method for manufacturing a construction element from a manufacturing assembly according to claim 6, said method comprising the following steps:
providing a mold suitable for a hardening fluid composition,
positioning, on a bottom of said mold, one or several luminescent inserts,
pouring a hardening fluid composition around said luminescent element(s), so as to embed a lateral surface of said luminescent element(s),
hardening said composition to form the block; and
assembling an end surface of said luminescent elements with luminescent inserts.

15. The method according to claim 13, comprising, before the step for pouring the hardening fluid composition, a step for positioning, on a bottom of the mold, several luminescent inserts or elements,
said positioning step being controlled by a computer program associating coordinates of each luminescent insert or element on the bottom of the mold with at least one visual parameter of said luminescent insert or element.

16. The luminescent insert according to claim 3, wherein the outer surface substantially has a substantially cylindrical or frustoconical shape of revolution.

17. The luminescent insert according to claim 4, wherein each facet is smooth and curved.

18. The assembly of claim 6, wherein said assembly surface (124) is substantially planar.

19. The assembly of claim 7, wherein said assembly surface (124) is substantially planar.

20. The construction element according to claim 9, wherein the hardened fluid composition (47) is a composition with a hydraulic binder base.
